(19) United States
(12) Patent Application Publication
(10) Pub. No.: US 2012/0273703 A1
(43) Pub. Date: Nov. 1, 2012

(54) Hands-free Faucet

(76) Inventors: Weimien Hsu, Taichung (TW); Chunhung Li, Taichung (TW); Chientang Chang, Taichung (TW)

(21) Appl. No.: 13/094,825

(22) Filed: Apr. 27, 2011

(51) Int. Cl. F16K 31/02

(52) U.S. Cl. 251/129.04

(57) ABSTRACT

A hands-free faucet contains a body fixed on a non-electrical conducting basin and including a spray head and a receiving groove; a manual control valve installed in the receiving groove and including a holder and a manual handle; the holder being made of an insulating material and including a first, a second channels, and an outlet channel; a tube assembly including a first tube, a second tube, and a third tube; a first extension, a second extension, and a third extension of the first tube, the second tube, and the third tube are made of insulating materials respectively; the third tube including an exposed section, and the exposed section including a solenoid valve; a proximity sensor module including a capacitive sensor and a controller; a power supply served to supply power toward the proximity sensor module.

### BACKGROUND OF THE INVENTION

1. Field of the Invention

The present invention relates to a hands-free faucet fixed on a non-electrical conducting basin made of a nonmetallic material.

2. Description of the Prior Art

A conventional automatic faucet has water saving function, because a water flow is only supplied after sensing user's hand and is stopped when the user's hand leaves away the automatic faucet.

The automatic faucet is controlled by using a spring and a proximity detector. Moreover, a conventional hands-free faucet is controlled by a power supply or a proximity detector to supply water automatically. The proximity detector of the hands-free faucet is driven by ways of an electro-optical diode, a sound wave signal, or a change of an amount of an electric charge near the hands-free faucet. The proximity detector is also capable of using a capacitive sensor to cooperate with a controller, and an insulator is defined between a body of the hands-free faucet and a basin so as to generate a detecting function.

However, such a conventional hands-free faucet has to equip with the insulator to decrease production cost, and the insulator is exposed outside to be interrupted, affecting an insulating effect to lower detecting sensitivity.

The present invention has arisen to mitigate and/or obviate the afore-described disadvantages.

### SUMMARY OF THE INVENTION

The primary object of the present invention is to provide a hands-free faucet which is capable of overcoming the shortcomings of the conventional hands-free faucet.

Further object of the present invention is to provide a hands-free faucet that is used in the basin made of nonmetallic material to match with the holder and the tube assembly which is made of an insulating material so as to further obtain an insulating effect. Thereby, an electric field is formed on an outer surface of the body by using the power supply and the proximity sensor module so that while user's hand is closed to a sensing range of the electric field, an amount of the electric charge of the outer surface of the body changes, hence a change of the amount of the electric charge is detected by the capacitive sensor of the proximity sensor module to transmit the signal toward the controller so that the solenoid valve is turned on.

Another object of the present invention is to provide a hands-free faucet that is capable of applying the holder to form an insulator without adding new insulating components to lower production cost. Also, the insulator is fixed in the hands-free faucet to prevent from external interference and to obtain an insulating effect.

To obtain the above objectives, a hands-free faucet provided by the present invention contains:

a body fixed on a non-electrical conducting basin to conduct electricity and including a spray head and a receiving groove located therein;

a manual control valve installed in the receiving groove of the body and including a holder and a manual handle; the holder being made of an insulating material to form an insulator and including a first inlet channel to flow a cold water, a second inlet channel to flow a hot water, and an outlet channel to flow the cold and the hot waters; the manual handle connecting with the holder to control the first inlet channel, the second inlet channel, and the outlet channel;

a tube assembly including a first tube to connect with the first inlet channel, a second tube to couple with the second inlet channel, and a third tube to join with the outlet channel and the spray head; a first extension, a second extension, and a third extension of the first tube, the second tube, and the third tube are made of insulating materials respectively; the third tube including an exposed section outside the body, and the exposed section including a solenoid valve secured thereon;

a proximity sensor module including a capacitive sensor and a controller; the capacitive sensor being electrically coupled with the body; the controller being used to transmit a signal sent from the capacitive sensor to turn on or off the solenoid valve;

a power supply served to supply power toward the proximity sensor module.

### BRIEF DESCRIPTION OF THE DRAWINGS

FIG. 1 is a cross sectional view showing the assembly of a hands-free faucet according to a preferred embodiment of the present invention;

FIG. 2 is a plan view showing the arrangement of a body, a manual control valve, a tube assembly, a proximity sensor module, a power supply, and a non-electrical conducting basin of the hands-free faucet according to the preferred embodiment of the present invention;

FIG. 3 is a plan view showing of a solenoid valve of the hands-free faucet according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

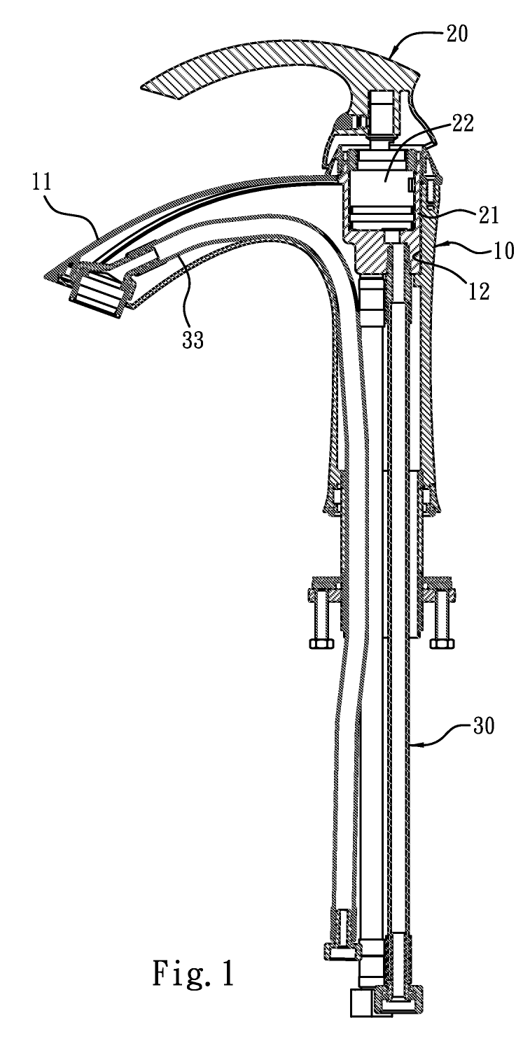

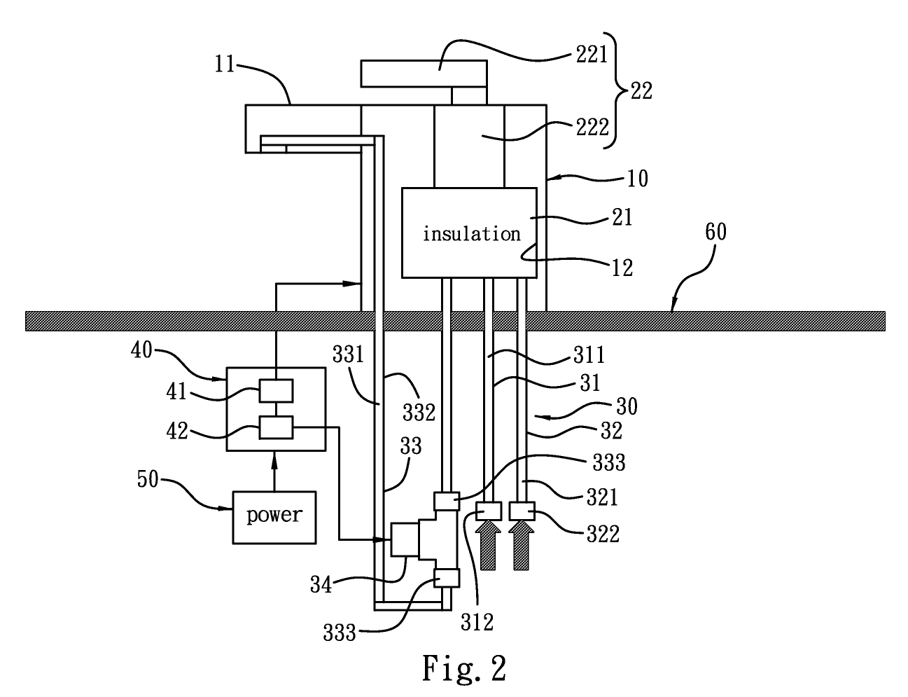

Referring to FIGS. 1 and 2, a hands-free faucet 1 according to a preferred embodiment of the present invention comprises a body 10, a manual control valve 20, a tube assembly 30, a proximity sensor module 40, and a power supply 50.

The body 10 is fixed on a non-electrical conducting basin 60 made of a nonmetallic material (such as ceramics) to conduct electricity and includes a spray head 11 and a receiving groove 12 located therein.

The manual control valve 20 is installed in the receiving groove 12 of the body 10 and includes a holder 21 and a manual handle 22; the holder 21 is made of an insulating material (such as ceramics) to form an insulator and includes a first inlet channel to flow a cold water, a second inlet channel to flow a hot water, and an outlet channel to flow the cold and the hot waters; the manual handle 22 further includes an operating lever 221 and a shaft 222 driven by the operating lever 221 to rotate, wherein the shaft 222 is made of an insulating material (such as ceramics) to form an insulator so that after the shaft 222 and the holder 21 connect with each other, between the operating lever 221 and the holder 21 generates an electrical isolation; the manual handle 22 is provided to control the first inlet channel, the second inlet channel, and the outlet channel.

The tube assembly 30 includes a first tube 31 to connect with the first inlet channel, a second tube 32 to couple with the second inlet channel, and a third tube 33 to join with the outlet channel and the spray head 11; a first extension 311, a second extension 321, and a third extension 331 of the first tube 31, the second tube 32, and the third tube 33 are made of insulating materials respectively; the third tube 33 also includes an exposed section 332 outside the body 10, and the exposed section 332 includes a solenoid valve secured thereon.

The first extension 311 and the second extension 321 of the first tube 31 and the second tube 32 include a first connector 312 and a second connector 322 arranged on two distal ends thereof individually, and the first connector 312 and the second connector 322 are made of insulating materials respectively; the exposed section 332 of the third tube 33 includes two third connectors 333 to connect with the solenoid valve 34 made of insulating materials individually.

The proximity sensor module 40 includes a capacitive sensor 41 and a controller 42; the capacitive sensor 41 is electrically coupled with the body 10; the controller 42 is used to transmit a signal sent from the capacitive sensor 41 to turn on or off the solenoid valve 34.

The power supply 50 is served to supply power toward the proximity sensor module 40, wherein the power supply 50 is a battery.

The hands-free faucet is used in the basin 60 made of nonmetallic material to match with the holder 21 and the tube assembly 30 which is made of an insulating material so as to further obtain an insulating effect. Thereby, an electric field is formed on an outer surface of the body by using the power supply 50 and the proximity sensor module 40 so that while user's hand is closed to a sensing range of the electric field, an amount of the electric charge of the outer surface of the body 10 changes, hence a change of the amount of the electric charge is detected by the capacitive sensor 41 of the proximity sensor module 40 to transmit the signal toward the controller 42 so that the solenoid valve 34 is turned on.

It is to be noted that the manual control valve 20 is set in a turn-on state, therefore as the solenoid valve 34 is turned on, the cold and the hot waters are mixed together at a proper ratio in the manual control valve 20 and then flow out of the spray head 11 of the body 10 along the third tube 33. On the contrary, as the solenoid valve 34 is turned off, a water supply is stopped to achieve hands-free operation.

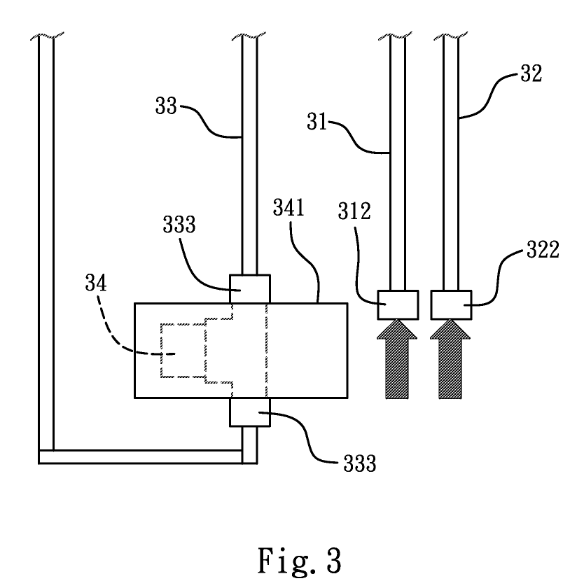

The first and second connectors 312, 322 of the first and second tubes 31, 32 and the two third connectors 333 of the third tube 33 are made of the insulating materials respectively to prevent the first tube 31 and the second tube 32 from crashing with the third tube 33 in assembly so that the body 10 is isolated from electricity. Furthermore, the solenoid valve 34 includes a valve box 341 made of an insulating material and covering the solenoid valve to generate insulation as shown in FIG. 3 so as to further prevent the first connector 312 and the second connector 322 of the first tube 31 and the second tube 32 from magnetically contacting with the solenoid valve 34 and the third connector 333, accordingly the first, the second, and the third connector 312, 322, 333 are capable of being made of electricity conducting materials respectively.

While we have shown and described various embodiments in accordance with the present invention, it is clear to those skilled in the art that further embodiments may be made without departing from the scope of the present invention.

What is claimed is:

1. A hands-free faucet comprising
a body fixed on a non-electrical conducting basin to conduct electricity and including a spray head and a receiving groove located therein;
a manual control valve installed in the receiving groove of the body and including a holder and a manual handle; the holder being made of an insulating material to form an insulator and including a first inlet channel to flow a cold water, a second inlet channel to flow a hot water, and an outlet channel to flow the cold and the hot waters; the manual handle connecting with the holder to control the first inlet channel, the second inlet channel, and the outlet channel;
a tube assembly including a first tube to connect with the first inlet channel, a second tube to couple with the second inlet channel, and a third tube to join with the outlet channel and the spray head; a first extension, a second extension, and a third extension of the first tube, the second tube, and the third tube are made of insulating materials respectively; the third tube including an exposed section outside the body, and the exposed section including a solenoid valve secured thereon;
a proximity sensor module including a capacitive sensor and a controller; the capacitive sensor being electrically coupled with the body; the controller being used to transmit a signal sent from the capacitive sensor to turn on or off the solenoid valve;
a power supply served to supply power toward the proximity sensor module.

2. The hands-free faucet as claimed in claim 1, wherein the first tube and the second tube include a first connector and a second connector arranged thereon individually, and the first connector and the second connector are made of insulating materials respectively; the exposed section of the third tube includes two third connectors to connect with the solenoid valve made of insulating materials individually.

3. The hands-free faucet as claimed in claim 1, wherein the first tube and the second tube include a first connector and a second connector arranged thereon individually; the exposed section of the third tube includes two third connectors to connect with the solenoid valve; the solenoid valve includes a valve box made of an insulating material and covering the solenoid valve.

4. The hands-free faucet as claimed in claim 3, wherein the first tube, the second tube, and the third tube are made of insulating materials respectively.

5. The hands-free faucet as claimed in claim 3, wherein the first, the second, and the third connectors are made of electricity conducting materials respectively.

6. The hands-free faucet as claimed in claim 1, wherein the manual handle and the holder connect with each other, and between the manual handle and the holder generates an electrical isolation.

7. The hands-free faucet as claimed in claim 6, wherein the manual handle includes an operating lever and a shaft driven by the operating lever to rotate; the shaft connects with the holder and is made of an insulating material.
